(19) United States
(12) Patent Application Publication
(10) Pub. No.: US 2018/0273171 A1
(43) Pub. Date: Sep. 27, 2018

(54) AIRCRAFT, RADIO NETWORK, AND METHOD FOR TRANSMITTING INFORMATION

(71) Applicant: RIEDEL Communications International GmbH, Wuppertal (DE)

(72) Inventor: Thomas RIEDEL, Wuppertal (DE)

(21) Appl. No.: 15/918,071

(22) Filed: Mar. 12, 2018

(30) Foreign Application Priority Data
Mar. 20, 2017 (DE) 102017105956.3

(51) Int. Cl. B64C 39/02

(52) U.S. Cl. CPC B64C 39/022; B64C 2201/148; B64C 2201/122; B64C 39/024

(57) ABSTRACT

The invention relates, among others, to an aircraft (10) comprising at least one electromotive drive (11a, 11b) and a controller (12) with which the aircraft can permanently maintain a set flight position, wherein the aircraft can be connected to the ground station (19) via a cable arrangement (16), and wherein the cable arrangement comprises at least two electric conductors (17a, 17b) for supplying voltage to the drive, as well as a fiber-optic cable (18) for the communication of data and/or signals.

The invention initially relates to an aircraft according to claim 1.

A standard aircraft is known and increasingly widespread. A traditionally standard aircraft is also known as a drone. It comprises a support structure or a supporting body on which a standard or rechargeable battery is mounted that is used to drive the at least one electric motor. As a rule, each of the motors has a drive assigned to it. Such drones or flying drones are also called multicopters. Depending on how many motors, and thus electromotive drives, are provided, one speaks for example of quadcopters, i.e. a drone with four motors.

Depending on the design, flying drones of this kind may, depending on the design, comprise a distinctly higher number of motors. Drones are known for example that have twelve or more drives.

The known aircraft obtains its voltage supply from usually a rechargeable replaceable accumulator (or battery). The flight duration of the aircraft is limited by the power rating of the battery. The aircraft comprises a predefined maximum payload so that there are limits as to the physical size of the battery.

Based on an aircraft that has become known through obvious previous use but for which there exist no printed publications, it is the requirement of the invention to further develop the aircraft in such a way that it can be used in new fields of application.

This requirement is met by the invention with the characteristics of claim 1.

The invention is an aircraft that comprises at least one electromotive drive. Preferably the aircraft according to the invention comprises a plurality of electromotive drives, in particular at least three electromotive drives. Further preferably the number of electromotive drives, i.e. the number of electric motors, corresponds to the number of existing rotors or propellers so that as a rule, each rotor has one electric motor assigned to it.

Moreover the aircraft comprises a control system, with which the aircraft can permanently maintain a set flight position. The control system is preferably electronics mounted directly on the aircraft and comprising in particular at least one processor that is able, with the aid of a suitable sensor system such as positional change sensors, and/or acceleration sensors, and/or position sensors, to ensure a stable or substantially stable relative spatial position of the aircraft. In particular, the control system is able to permanently maintain the desired flight position without requiring continuous or regular intervention by an operator.

To this end recourse may be made to conventional control systems and control methods that on conventional aircraft, in particular on conventional drones, are already in use and that are known as such.

The aircraft thus can be directed by a user-guided control in direction of a certain location, e.g. a certain position at a certain distance from a fixed body attached to the ground and can thus automatically permanently maintain the chosen flight position.

According to the invention the aircraft can be connected via a cable arrangement to a ground station. To this end the aircraft comprises in particular at least one port for the releasable connection of the aircraft to a cable arrangement. The cable arrangement can moreover be connected to a ground station. The ground station is firmly anchored to the ground.

The cable arrangement can comprise a length of for example between 5 and 500 meters, preferably a length of between 50 and 120 meters. The aircraft can be brought into a flight position that comprises a maximum height, i.e. a distance from the ground that corresponds to the length of the cable arrangement.

According to the invention it is furthermore provided that the cable arrangement comprises at least two electric conductors for supplying voltage to the drive.

To this effect the aircraft receives the operating voltage with which the electromotive drives are supplied directly from the ground station via the cable arrangement. Insofar there is no need any more for the aircraft to carry along its own battery or accumulator. The voltage supply of the drive may be achieved exclusively, or at least partially or temporarily, via the cable arrangement. In particular, because a permanent voltage supply is ensured, the aircraft may remain in its set flight position for practically any length of time, such as for example for several hours or for several days.

It should be noted that the aircraft, due to the possibility provided by the invention of maintaining the set flight position for a distinctly longer time, also has the possibility according to an advantageous design of the invention of correcting the actually existing flight position relative to the set flight position and is able to perform such a correction.

Whilst the control of an aircraft of the conventional kind already incorporates surprisingly exact and precise mechanisms enabling it, even in the case of wind, and even in very windy conditions, to maintain its set flight position, it may be necessary, in view of the possible continuous operation over several hours or even several days (up to weeks) as provided according to the invention, to perform as required a correction of the actually achieved flight position with regard to the required set flight position. To this end the aircraft may be equipped with special position correction means that for example in case of deviations beyond the predetermined set limits from the set flight position, ensure an automatic return of the aircraft into the set flight position. To this end GPS positioning or repositioning aids or other suitable position measuring and position correcting procedures may be provided.

According to the invention it is moreover provided that the cable arrangement comprises a fiber-optic cable for communicating data and/or signals.

According to the invention the cable arrangement is configured as a kind of hybrid cable. The cable arrangement includes at least one glass fiber that permits the transmission of data or signals in an optical manner. To this end data and/or signals can be transmitted between the aircraft and the ground station, in a unidirectional or bidirectional manner. The fiber-optic cable permits very high data transmission rates, and in particular offers the especially simple option of coupling data and/or signals into or out of the glass fiber both on the aircraft and on the ground station.

One data transmission method in particular is considered that functions as radio-over-fibre (RoF) or RF-over-fibre (RFoF). This technology is used to modulate a light current guided over the glass fiber with a radio frequency signal.

The cable arrangement also includes at least two electric conductors for supplying voltage to the drive. The electrical drives on the aircraft can be provided either with direct voltage or with alternating voltage via the at least two electric conductors.

The cable arrangement according to the invention can fall back on conventional electric conductors and conventional fiber-optic cables and combine these with each other to form a cable arrangement according to the invention. Two electric conductors (or even a number of electric conductors) can for example be bonded to a conventional glass fiber, e.g. by gluing or welding or spot welding in sections or in places. The invention, however, also covers hybrid cable arrangements, in which for example a fiber-optic cable is enveloped by two electrically conducting sheaths that are separated from each other by an intermediate layer.

The hybrid cable arrangement according to the invention can be realized for a length of 100 meters with a weight in the region of approx. 4 kilograms. A conventional flying drone can support payloads of e.g. 15 kilograms. After subtracting the approx. 4 kilograms for the hybrid cable arrangement, the remaining payload is e.g. 11 kilograms.

This permits the arrangement of transmission and reception technology on the aircraft including the arrangement of electro-optical converters or optical-electrical transducers that perform the coupling of signals into and out of the glass fiber.

The technology to be installed on the aircraft may be limited to antennae, filters, e.g. duplexers, transmitting and receiving amplifiers and transducers.

The heavy signal processing technology including the transmitting and receiving technology and the amplifiers, which is far more complex than the transmitting and/or receiving technology on the aircraft, may be arranged on the ground station. In any case it would not be possible to arrange it on the flying drone on account of the small payloads.

The aircraft according to the invention can thus be used as a central element of a radio network. In particular, the aircraft can be used for radio networks that are only temporarily established, for example for the purposes of reporting at big sports event or other events. Here the problem is frequently bad radio quality, for example due to shadowing. To this end it was commonly known in the art to provide lifting platforms that, mounted in the lifting truck, comprise the heavy transmitting and receiving equipment and that due to their raised position well above the ground, permitted a good radio link to individual subscribers. According to the invention there is then no need for such lifting trucks when the aircraft according to the invention is used.

The aircraft has at least one antenna mounted on it according to the invention. The antenna may be used as receiving antenna or as transmitting antenna or as a transmitting and receiving antenna.

The aircraft according to the invention can be used in a radio network in order to establish a radio link to a plurality of subscribers. In a first operating mode the aircraft is configured to receive radio signals sent by subscribers, to feed them via an electro optical transducer into the glass fiber and forward them to a ground station. In the ground station the signals are then decoupled with the aid of an opto-electronic transducer, possibly with the interposition of an amplifier, from the glass fiber and processed further.

According to a further alternative operating mode the aircraft is configured to send radio signals to subscribers of the radio network with the aid of an antenna mounted on the aircraft. To this end signals are fed into the glass fiber by the ground station with the aid of an electro optical transducer and decoupled with the aid of an opto-electronic converter on the aircraft and then emitted, possibly after amplification, via the antenna.

The two above-described operating modes can both be achieved in a unidirectional operation of the cable arrangement.

The invention also covers the case where the aircraft is operated in both a transmitting and a receiving mode as part of a bidirectional operation. In this case the aircraft can be used as a kind of optical repeater and communicate the signals received from the subscribers of the radio network to the ground station for the purpose of amplification, and following receipt of the amplified signals by the ground station, re-emit these signals as radio signals. As a result the radio network quality and the range of the radio networks is considerably improved.

The invention also covers the case, where one or more antennae are mounted on the aircraft.

Further, the invention covers the case, where the cable arrangement comprises one or more glass fibers.

In general it is possible to use a fiber-optic cable for bidirectional operation.

The at least two electric conductors to supply voltage to the electromotive drive, may also be used as voltage supply for the electronic components of the signal transmitting and receiving technology on the aircraft. But the invention also covers the case, where the voltage supply for the transmitting and receiving technology on the aircraft is achieved by arranging for further separate electric conductors to be part of the cable arrangement.

Generally, however, the invention aims at using as lightweight a construction as possible for the cable arrangement. According to an advantageous design of the invention a transmitter and/or receiver for radio signals is mounted on the aircraft. The transmitter and/or receiver for radio signals may comprise one or more antennae. Moreover it may comprise one or more electronic components that perform the necessary signal processing in order to forward received radio signals to the electro optical transducer for the purpose of optically coupling the same into the fiber-optic cable and/or that comprise the necessary electronic components in order to convert optical signals fed out of the glass fiber into electric signals and process them in such a manner that these can be emitted via an antenna.

Basically provision of the transmitter and/or receiver on the aircraft may be accomplished by using conventional electronic components.

According to the invention it is moreover provided to arrange a transducer on the aircraft that converts electronic signals into optical signals that can be fed into the fiber-optic cable. Furthermore or alternatively a transducer may be provided on the aircraft that converts optical signals that can be coupled out of the fiber-optic cable into electrical signals. Here again, the invention can fall back on conventional electronic components and elements for the transducer.

According to a further advantageous design of the invention the aircraft comprises a port to which the fiber-optic cable can be releasably attached. This can be done using conventional interfaces. The ports may be plug-in connections for example.

According to a further advantageous design of the invention the aircraft can be connected to the ground station via a cable arrangement. Using this cable arrangement it can be achieved that the aircraft can maintain a set flight position with continuous supply of voltage over very long periods of time.

According to a further advantageous design of the invention the aircraft is configured as a kind of drone. Further advantageously the aircraft is configured as a kind of multicopter, for example as a kind of quadcopter. This makes it possible to fall back on aircraft that can be modified according to the invention, for example can be provided with a transmitter/receiver, with a transducer, and/or with a port for a cable arrangement. The aircraft according to the invention may also be configured as a kind of helicopter and in particular comprise two rotors or two rotor assemblies.

In particular aircraft in terms of the present patent application are understood to be helicopters that comprise at least one rotor that rotates about an essentially vertically aligned axis, and at least one further rotor that rotates about an essentially horizontally aligned axis. With helicopters of this kind the pitch of the rotor blades may be set with the aid of a swash plate, as is known with conventional helicopters for setting the pitch, i.e. for setting the incline or the pitch angle of the rotor blades.

The invention further relates to a radio network according to claim 7.

The invention is based on the requirement to provide a radio network that permits an improved radio network quality and/or an improved range.

This requirement is met by the invention with the characteristics of claim 7.

As regards the understanding of the terms and characteristics of the subject of claim 7, in order to avoid repetitions reference is made to the statements made with regard to claims 1 to 6.

The radio network according to the invention includes at least one ground station, at least one aircraft, and at least one cable arrangement, via which the aircraft is connected to the ground station. The aircraft has at least one electromotive drive provided on it, which requires to be supplied with an operating voltage. To this end the cable arrangement comprises at least two electric conductors.

Moreover, the cable arrangement comprises at least one fiber-optic cable.

The radio network according to the invention includes—apart from the aircraft—one or more radio network subscribers. These may be for example stationary but also mobile subscribers, i.e. subscribers that may alter their position.

The radio network subscribers may, depending on the operating mode, receive and/or send radio data. The radio data sent by the subscribers may be received, according to a first variant, by a receiver for radio signals mounted on the aircraft.

According to a second variant the radio network subscribers can receive radio data. According to this operating mode the respective radio data can be sent from a transmitter mounted on the aircraft.

The invention also covers radio networks that are able to function in both previously described operating modes, either simultaneously or with a time-delay.

Radio data is thus understood to be information that can be exchanged unidirectionally or bidirectionally between the transmitter or receiver mounted on an aircraft and the individual subscribers.

The radio signals may, for example, lie in the megahertz range, for example in the L band frequency range between 950 megahertz and 2,150 megahertz, but also in other frequency ranges.

These radio data can be communicated via the fiber-optic cable from the aircraft to the ground station and/or from the ground station to the aircraft. As an alternative to communicating radio data the invention also covers the communication of signals that correspond to the radio data.

According to one variant the radio network is configured as an intercom network/allows the use or utilization of the radio network as an intercom network. Here individual subscribers or at least some of the subscribers may have intercom systems and can exchange information with each other with the aid of the radio network.

Apart from the exchange of audio data the radio network can also be used for the exchange of voice data, image data or other information or data.

According to a further advantageous design of the invention the radio data includes video and/or image information and/or audio information.

According to a further aspect of the invention the invention relates a method for transmitting information according to claim 10.

The invention is based on the requirement to provide a method, with which the transmission of information is improved.

This requirement is met by the invention with the characteristics of claim 10.

In order avoid repetition, reference is made, as regards the meaning and interpretation of the characteristics and the understanding of the invention according to claim 10, to the statements as regards claims 1 to 9.

Further advantages of the invention are revealed in the sub-claims not cited and the exemplary embodiments described hereunder with reference to the figures, in which

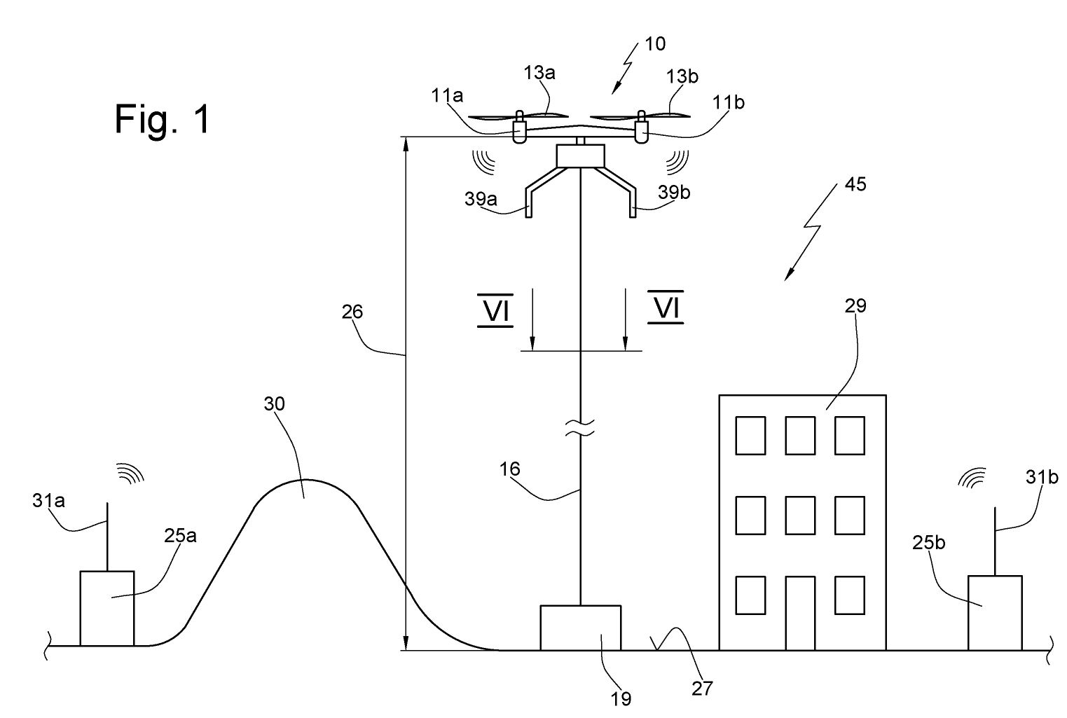

FIG. 1 in a schematic partly sectional view, shows an embodiment of a radio network according to the invention including a first embodiment of an aircraft according to the invention in a schematic partly sectional view,

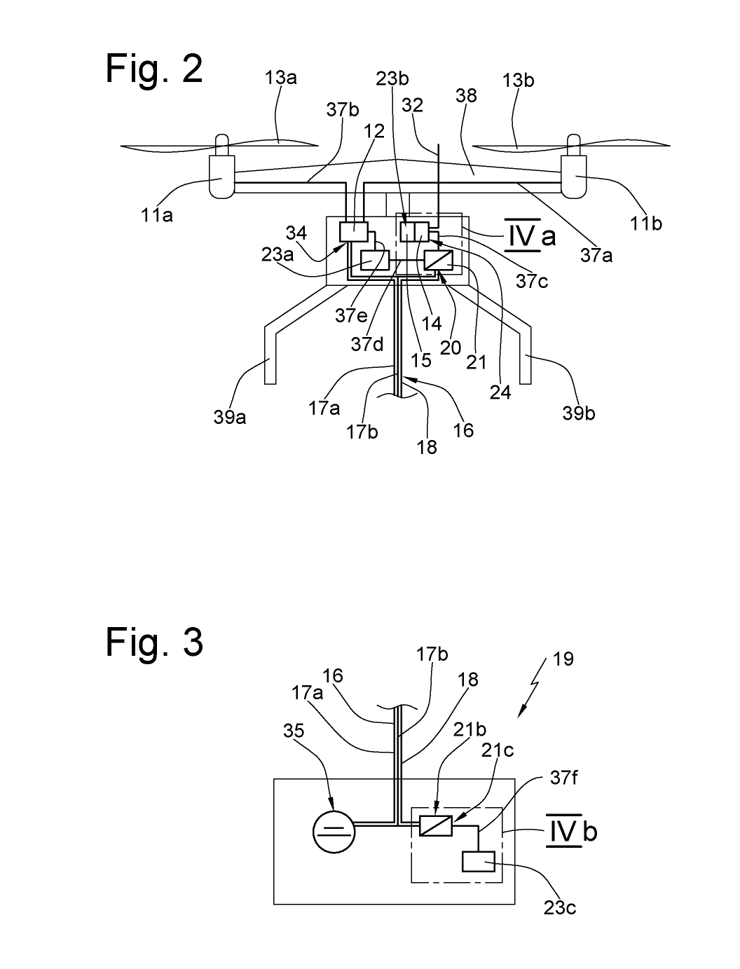

FIG. 2 in a schematic partly sectional view, shows the aircraft of FIG. 1 in an enlarged individual view, wherein some electronic components are showed as a kind of block diagram,

FIG. 3 shows the ground station of FIG. 1 in an enlarged schematic individual view, wherein some electronic components are showed as a kind of block diagram,

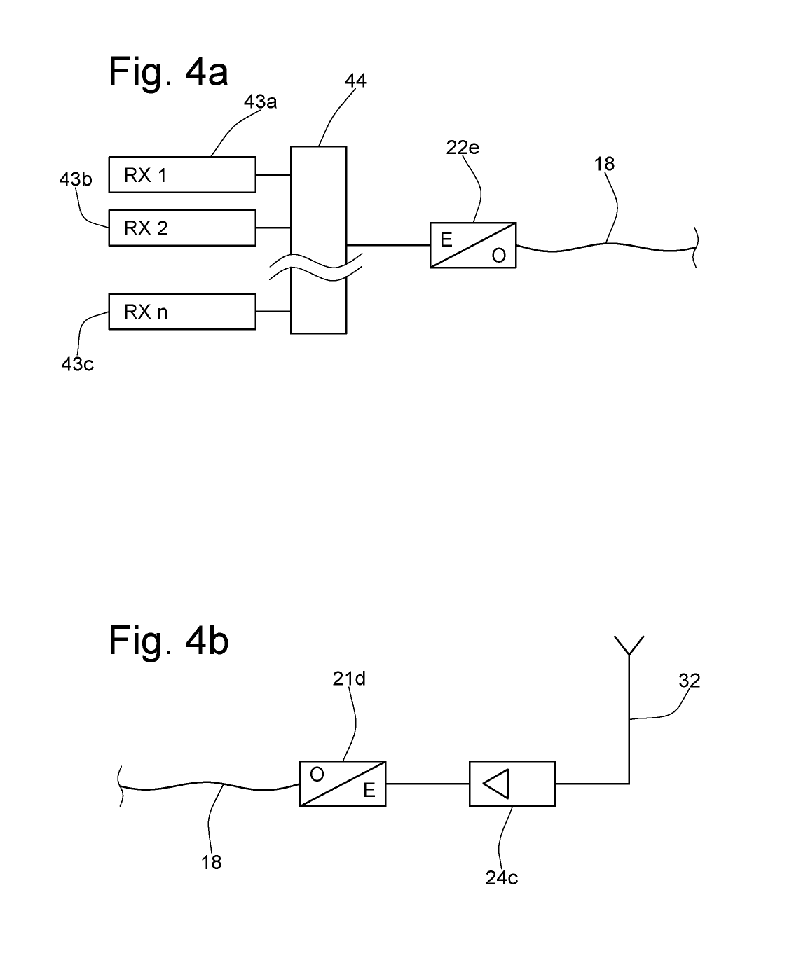

FIGS. 4a and 4b show an overview of the circuit layout from the antenna to the receiver as a receive branch,

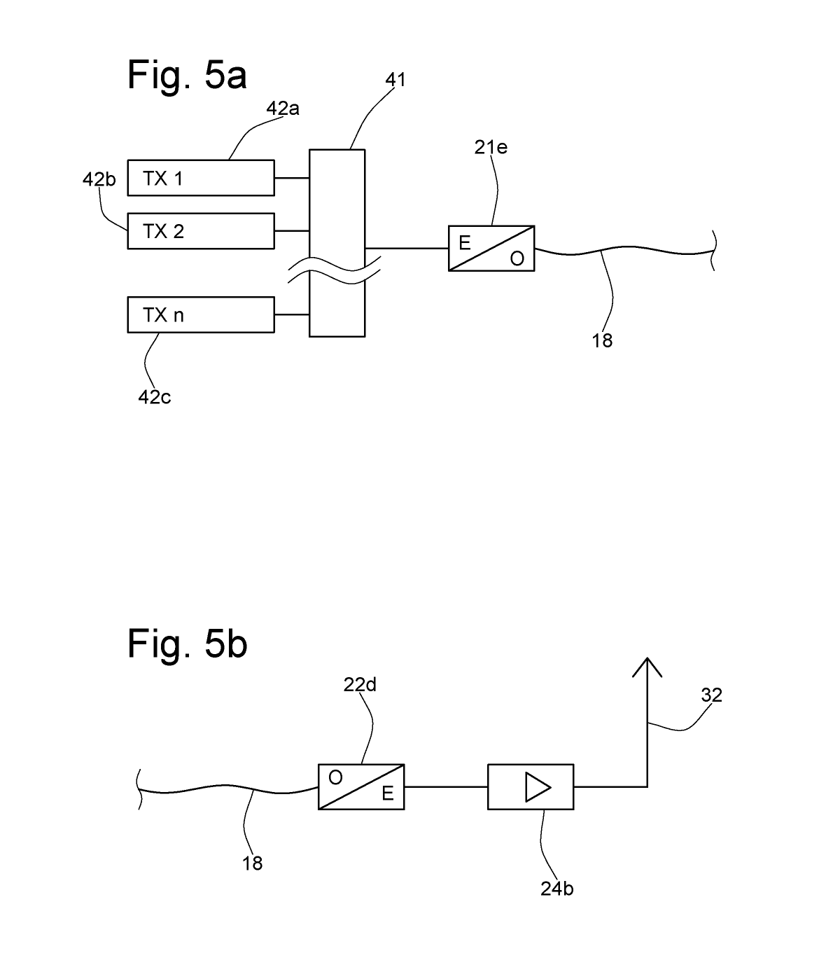

FIGS. 5a and 5b show an overview of the electronic circuit from the receivers to the antenna, laid out as a transmit branch,

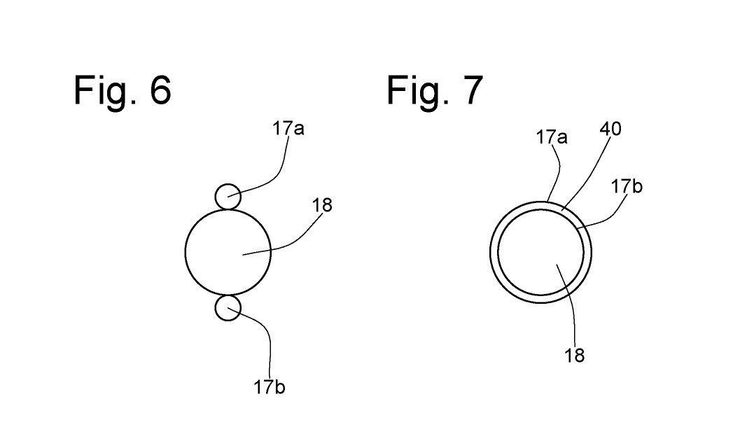

FIG. 6 in a schematic partly sectional view, shows a schematic cross-section through the cable arrangement of FIG. 1, roughly along line VI-VI in FIG. 1, and

FIG. 7 in a view like FIG. 6, shows a further embodiment of a cable arrangement in cross-section.

Exemplary embodiments of the invention will now be described by way of example in the description hereunder of the figures with reference also to the drawings. For clarity's sake, also insofar as different embodiments are concerned, identical or comparable parts or elements or areas are denoted with the same reference symbols, partly by adding lower-case letters.

Features that are described with reference to only one embodiment, may, in terms of the invention, also be provided in any other embodiment of the invention. Embodiments altered in this way are covered by the invention, even if they are not showed in the drawings.

All disclosed features are, on their own, essential to the invention. Disclosure of the application herewith includes, in full, the disclosure content of the associated priority documents (copy of prior application) as well as of the cited publications and described devices of the state of the art, also for the purpose of including individual or several features of these documents in one or in a number of claims of the present application.

The aircraft denoted with 10 in its entirety in the drawings comprises four rotors according to the embodiment as per the views of FIGS. 1 and 2, wherein only two rotors 13a, 13b are visible. Each rotor or propeller is assigned its own drive 11a, 11b that is configured as an electric motor and, in terms of this patent application, is also called an electromotive drive 11a, 11b. A controller 12 showed in FIG. 2 as a schematic block diagram is capable, by means of controlling the drives 11a, 11b via respective control lines 37a, 37b, to move the aircraft 10 into a predetermined or desired flight position/to perform a desired flight movement of the aircraft 10.

According to the detail view shown in FIG. 2, the drone 10, i.e. the aircraft, comprises a merely schematically indicated supporting body 38 that supports the rotors 13a, 13b, the drives 11a, 11b and the entire electronics explained in detail at a later stage. Feet 39a, 39b permitting a safe landing of the aircraft 10 extend indirectly or directly downwards from the supporting body 38.

According to FIG. 1, the aircraft can lift off the ground 27 and achieve a maximum height 26. The height 26 may, for example, be between 50 and 100 meters.

The aircraft 10 is connected via a cable arrangement 16 to a ground station 19 showed schematically in FIG. 1.

With the aid of the aircraft 10 a radio network denoted as a whole with 45 can be established that can have any number of subscribers 25a, 25b. By means of the indicated antennae 31a, 31b, radio signals can be communicated by the subscribers 25a, 25b to the aircraft 10. The aircraft 10 can, as shown in FIG. 2, also have an antenna 32, in this case a receiver antenna.

With another operating mode or simultaneously, as required, radio signals that then can be received by the subscribers 25a, 25b, may be emitted by the aircraft 10 with the aid of the antenna 32 that is then configured as a transmitter antenna.

The drone 10 advantageously used to provide an inventive radio network 45 is then employed in such a way as to comprise a height 26 that exceeds the heights of ground unevenness's 30 and/or buildings 29 or other obstructions. In this way a direct transmission path that is kept free of obstacles can be established between the subscribers 25a, 25b and the aircraft 10.

Advantageously the height 26 may be between 30 and 200 meters.

The cable arrangement 16 includes at least two electric conductors 17a, 17b, via which the drives 11a, 11b can receive a voltage supply. The supplied voltage may be a direct voltage or an alternating voltage.

The cable arrangement 16 is, to this end, releasably connected directly or indirectly via a port on the aircraft 10 to the controller 12. The controller 12 can effect control of the drives 11a, 11b and thus also of the robots 13a, 13b in accordance with the received flight commands for achieving the desired flight position. The flight commands can receive the control either via the electric conductors 17a, 17b, possibly as modulated-on signals, or via the glass fiber line 18 or via a separate transmission path from an in particular operator-guided ground-based controller or possibly directly from the ground station.

According to the embodiment of FIG. 2 the port 34 is arranged on an electronic component that comprises the controller 12. Control lines 37a, 37b may, as showed in FIG. 2, extend from this component to the respective drives 11a, 11b. The control, in particular the intelligence or logic arranged therein, e.g. a microprocessor, can provide the respective control for the drives 11a and 11b, and supply the operating voltage via the control line 37a, 37b to the electric motors 11a, 11b in a controlled manner. Alternatively, starting from a port 34, the voltage supply lines may be initially split such that each of the electric motors 11a, 11b is connected to its own voltage supply line, and separate signal lines additionally extend from the controller 12 to the individual electric motors 11a, 11b.

The decision on which layout to choose is left to the expert.

The conductors 17a, 17b, in the area of the ground station 19 as per FIG. 3, are connected to a voltage source 35, for example to a battery, but preferably to the mains supply or a generator. Connection may be effected, as required, via transformers or the like mounted in between.

The ground station 19 may equally comprise a port not showed for the cable arrangement 16, via which the cable arrangement 16 can be releasably connected to the ground station. The cable arrangement 16 can, as required, be wound onto a cable winch and wound off the same.

The cable arrangement 16 moreover comprises a fiber-optic cable 18. The fiber-optic cable 18 is connected to the aircraft 10 via a port 20. The ports 20, 34 provide a releasable connection between cable arrangement 16 and aircraft. A plug-in connection in particular is a suitable connection.

According to one variant of the invention a common port may be provided for both connections 20 and 24.

The electronic circuit for the components of the aircraft 10 is merely schematically indicated in FIG. 2.

The aircraft 10 comprises an antenna 32 that is indirectly or directly connected to a transmitter 14 for radio signals or with a receiver 15 for radio signals. According to FIG. 2 the aircraft 10 comprises a combined transmitter and receiver 14, 15 for radio signals so that, theoretically at any rate, a bidirectional radio receiving and transmitting operation is possible.

The transmitter and receiver 14, 15 is connected via a signal line or control line 37c to a transducer 21. The transducer converts electrical radio signals received by the receiver 15 into optical signals, and provides for these signals to be fed into the glass fiber 18.

According to FIG. 3 the ground station 19 also comprises a transducer 21b connected to the glass fiber 18 that decouples the optical signals from the glass fiber 18 and converts them into electrical signals. The transducer 21b is connected via a control line 37f to the signal processing unit 23c.

With this embodiment it is thus possible that the antenna 32 receives signals from the subscribers 25a, 25b of the radio network 45 and forwards them to the receiver 15. From here the signals are communicated to a transducer 21 that couples the signals into the glass fiber, guides them to the ground station 16, where they are decoupled by the transducer 21b and converted into electrical signals that are processed by the signal processing unit 23c.

In reverse operating mode the aircraft 10 can become a transmitter station.

Here signals are sent from the signal processing unit 23c via the line 37f to a transducer 21c that converts the electrical signals from the signal processing unit 23c into optical signals and couples these into the glass fiber. The transducer 21 on the aircraft 10 is now an opto-electronic transducer and converts the signals decoupled from the glass fiber 18 into electrical signals, communicates these to a transmitter 14, from where they are emitted via the antenna 32. In this way radio signals in the radio frequency range can be communicated to the subscribers.

The respective electronic components for the processing and forwarding of the signals are showed in FIGS. 4a and 4b and 5a and 5b.

FIG. 4b describes the receiver branch:

Signals are present at the antenna 32 of the aircraft 10 that to start with are amplified by an amplifier unit 24c. It should be noted that the receiver 15 of the aircraft 10 of FIG. 2 can form or comprise such an amplifier unit 24c.

From the amplifier unit 24c the electrical signals are communicated to a transducer 21d that converts the electronically present signals into optical signals and couples them into the glass fiber 18.

The receiver branch in the area of the ground station 19 is detailed in FIG. 4a.

The signals present in the glass fiber 18 are converted following decoupling by the transducer 22a into electrical signals and then forwarded to a HF distribution unit 44. From there the signals reach the receivers 43a, 43b, 43c.

FIGS. 5a and 5b show processing of the signals in transmission mode.

Starting with the transmitters 42a, 42b, 42c in the area of the ground station 19 the signals are initially communicated to a high frequency combiner unit 41 (HF combiner). From there the signals are fed via an electro optical transducer 21e into the glass fiber 18. According to 5b, in the area of the aircraft 10, the signals are decoupled by a further transducer 22d and converted from optical into electronic signals. Then the amplifier unit 24b can amplify the radio signals present there and communicate them to the antenna 32. The antenna then emits the signals. The amplifier unit 24b can be the transmitter 14 for radio signals as per FIG. 2 or it can be part of such a transmitter 14.

It will be clear to the expert that further electric and electronic components such as for example filters may be provided that are conventionally known from RF technology and may accordingly be provided at the ground station 19/the aircraft 10.

In this respect it is of particular importance that the heavy components and elements used in the transmission and reception technology such as for example the individual receivers 43a, 43b, 43c and the individual transmitters 42a, 42b, 42c as well as the HF distribution units 44/HF combiners 41 are mounted on the ground station 19 due their heavy weight.

According to a particular design of the invention the aircraft 10 can operate bidirectionally thereby establishing a radio network 45. Here the aircraft 10 together with the ground station 19 and the cable arrangement 16 can function in the manner of an optical repeater. To this end the signals in the glass fiber are communicated in both directions (bidirectionally). The signals received by the receiver 15 are passed to the ground station, where they are amplified/processed, then transmitted back via the glass fiber 18 to the aircraft 10 and thereafter re-transmitted by the transmitter 14 for radio signals. This allows radio networks of high network quality and with a wide operating range to be achieved.

The radio network is established in that the operator merely allows the drone 10 with cable arrangement 16 already affixed to it to ascend and he then guides it into the desired position. As the drone gains height the cable arrangement 16 may for example be unrolled from a cable winch or a rewind shaft or spool.

After reaching the desired flight position a special device that may be part of the controller 12 or cooperate therewith, can ensure that the achieved flight position is permanently maintained, in particular by means of measuring movements and/or accelerations and/or positions.

Once the aircraft 10 has fulfilled its function, it can be returned to the ground surface 27 by a user-guided or automatic control. At the same time the cable arrangement 16 can be rolled up again or rewound.

FIGS. 6 and 7 show merely schematically possible constructional designs of the cable arrangement 16.

According to FIG. 6 it may be provided that the two conductors 17a, 17b are attached spaced apart on the outer shell surfaces of the glass fiber 18. For example they can be welded or glued together or attached thereto in another way. The two conductors 17a, 17b may, which is not shown in FIG. 6, be completely electrically insulated from each other and provided, for example with an insulating sheath.

According to FIG. 7, with one embodiment of the invention, the glass fiber 18 may be enwrapped by a first core 17 configured like a shell, the core in turn being enwrapped by an insulating layer, on the outside of which a second electrical conductor core is mounted. Other constructional designs of the cable arrangement 16 are feasible and covered by the invention.

1. An aircraft, comprising at least one electromotive drive and a controller, with which the aircraft can permanently maintain a set flight position, wherein the aircraft can be connected via a cable arrangement to a ground station, and wherein the cable arrangement comprises at least two electric conductors for supplying voltage to the drive and a fiber-optic cable for communicating data and/or signals.

2. The aircraft according to claim 1, wherein a transmitter and/or a receiver for radio signals is mounted on the aircraft.

3. The aircraft according to claim 1, wherein a transducer is mounted on the aircraft that converts the electronic signals into optical signals that can be fed into the glass fiber, and/or that converts optical signals that can be decoupled from the glass fiber into electrical signals.

4. The aircraft according to claim 1, wherein the aircraft comprises a port via which the fiber-optic cable can be releasably attached.

5. The aircraft according to claim 1, wherein the aircraft is connected via the cable arrangement to the ground station.

6. The aircraft according to claim 1, wherein the aircraft is configured as a drone.

7. A radio network, comprising at least one ground station, an aircraft connected to the ground station via a cable arrangement and comprising at least one electromotive drive a, and one or more radio network subscribers that receive and/or transmit radio data, wherein the radio data can be transmitted or received by a transmitter and/or receiver for radio signals mounted on the aircraft, and wherein the cable arrangement includes at least two electric conductors for providing an operating voltage for the drive as well as a fiber-optic cable for communicating radio data and/or signals corresponding to the radio data.

8. The radio network according to claim 7 wherein the radio network is configured as an intercom network.

9. The radio network according to claim 7, wherein the radio data comprise image information and/or audio information.

10. A method of transmitting information between an aircraft and a ground station, comprising the following steps:
a) providing a cable arrangement between the aircraft and the ground station, wherein the cable arrangement comprises at least one fiber-optic cable,
b) providing two electric conductors as part of the cable arrangement,
c) providing an operating voltage for at least the drive of the aircraft, on the aircraft via the at least two electric conductors; and
d) communicating information between the aircraft and the ground station and/or between the ground station and the aircraft.

11. The method according to claim 10, wherein data and/or signal transmission between the ground station and the aircraft is carried out unidirectionally or bidirectionally via the fiber-optic cable.
